(19) United States
(12) Patent Application Publication
(10) Pub. No.: US 2024/0193162 A1
(43) Pub. Date: Jun. 13, 2024

(54) System and Method for Joining Datasets

(71) Applicant: Ikigai Labs, Inc., San Francisco, CA (US)

(72) Inventors: Arth Dharaskar, Cambridge, MA (US); Nathaniel Clinton Lanier, Cambridge, MA (US); Vinayak Ramesh, Cambridge, MA (US); Amar Himansu Shah, Cambridge, MA (US); Devavrat Dilitkumar Shah, Cambridge, MA (US); Jaehyun Sim, Cambridge, MA (US)

(21) Appl. No.: 18/581,642

(22) Filed: Feb. 20, 2024

Related U.S. Application Data
(63) Continuation-in-part of application No. 18/184,834, filed on Mar. 16, 2023.
(60) Provisional application No. 63/269,506, filed on Mar. 17, 2022.

(51) Int. Cl. G06F 16/2453; G06F 16/22

(52) U.S. Cl. CPC G06F 16/24537; G06F 16/2282

(57) ABSTRACT

A computer-implemented method includes receiving a first dataset including a first table having a first number of parts, where each part of the first number of parts represents either a row or a column of the first table and receiving a second dataset including a second table having a second number of parts, where each part of the second number of parts represents either a row or a column of the second table. For each part of the first number of parts the method includes forming a string representation of the part from a number of values associated with the part and determining a numerical representation of the string representation of the part. For each part of the second number of parts, the method includes forming a string representation of the part from a number of values associated with the part and determining a numerical representation of the string representation of the part. The method includes determining a mapping between at least some parts of the first table and second table including determining that a first set of one or more parts of the first number of parts correspond a second set of one or more parts of the second number of parts based at least in part on a similarity between numerical representations of the parts.

### CROSS-REFERENCE TO RELATED APPLICATIONS

This application is a continuation-in-part of U.S. patent application Ser. No. 18/184,834 filed Mar. 16, 2023, which claims priority to U.S. Provisional Application No. 63/269,506, entitled “Systems and Methods For Joining Datasets,” filed on Mar. 17, 2022, both of which are hereby incorporated by reference.

### TECHNICAL FIELD

This application relates generally to the analysis and processing of information contained in datasets such as databases, tables, and spreadsheets.

### BACKGROUND

The use of databases, tables and spreadsheets to organize information and data is widely and long used. Computer applications that facilitate such management of information pervade almost every sector of business, science, healthcare, education, the financial industry and other sectors. Traditionally, a user purchases, subscribes, installs or otherwise adopts a given vendor's platform (e.g., a suite of software including database or spreadsheet applications) and learns how to use the vendor's platform. The user imports or enters information in the form of data in a form and format that is compatible with the chosen platform. Well-known examples have been available from Lotus, Microsoft and Google. Since some software products become commercially successful or dominant, a community of users grows around the dominant platforms. This enables the easy sharing and transport of data and data files compatible with these platforms among the community of users. However, one problem can arise if a user wishes to use or implement a project on data that is created or formatted or organized for compatibility with a platform different from the platform the user wishes to use. Some imperfect solutions have been developed to address this issue whereby a utility or import function can identify the form of the data being imported and convert it to a different form that is usable with another platform. This solution can be subject to errors or failures as the platforms are often updated over time and the internal details of the platforms are only known to the vendors supplying said platforms, sometimes intentionally or unintentionally being opaque and/or proprietary in nature.

Another issue with processing and managing data in multiple databases, tables, or spreadsheets (generally “datasets”) is that of joining. Here, a user wishes to merge, combine, stitch, consolidate, or mingle (generally “join”) some or all information between more than one data file or dataset each containing some data that is separately or originally organized and formatted in its respective file or dataset. The joining issue can arise whether the two original datasets share a same platform or whether they come from different platforms as discussed earlier. It is common that two original datasets, even if the datasets describe the same or similar subject matter, can be differently organized or differently annotated. We may refer to this by saying that the different datasets share or do not share common keys that can be identified by a computer system to join the datasets. Stated differently, the notation and/or organization of the contents of the datasets can therefore be different even though they refer to the same or similar subject, making it challenging for a simple computer application to match corresponding elements of two datasets together. Many examples of datasets which pose challenges to joining may be considered. For example, if two datasets describe ambient temperature in a respective column entitled “Temperature”, one of the datasets may list the temperature entries in degrees Celsius while the other dataset may list the temperature entries in degrees Fahrenheit. If the operator or the computer application were to recognize that both of these columns refer to the same thing (because they both have the same heading or title “Temperature”) then it could be relatively easy to join these datasets by making a suitable conversion between the Celsius and Fahrenheit unit systems. Another example of a joining issue can arise if the data columns relate to pricing where the units of currency are in different currencies. One dataset list a “Price” in Euros while the other dataset lists the “Price” in US Dollars. Here, not only is there a unit conversion involved, but the conversion factor may be time dependent as the two currencies fluctuate in relative value over time. But again, this joining issue can be resolved through suitable programming of the system performing the join operation.

Even more challenging situations occur where the datasets to be joined and their respective contents are not identified with the same headings or titles. While it is clear to assume that two columns entitled “Temperature” in two datasets refer to the same class of information (temperature), it is less obvious to join two columns of data if one dataset refers to “Name” and the other refers to “Customer” even though both dataset columns may be referring to the name of a customer. Additionally, joining problems can arise if the nature or format of the data entries themselves is inconsistent within one or more of the datasets to be joined. For example, one dataset may refer to the name of a customer as “John Smith” while the other may refer to the same person as “Smith, John” or “J. Smith” or “Smith_John”, or even identify the same person by information other than their given name (e.g., an ID number, a user name, or even a genetic or biometric identification factor). In yet other examples, specific data entries may differ or may be missing from one of the datasets being joined where it is present in the other, which again complicates the automation of a process for joining such two or more datasets.

### SUMMARY

Example embodiments described herein have innovative features, no single one of which is indispensable or solely responsible for their desirable attributes. The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Without limiting the scope of the claims, some of the advantageous features will now be summarized. Other objects, advantages and novel features of the disclosure will be set forth in the following detailed description of the disclosure when considered in conjunction with the drawings, which are intended to illustrate, not limit, the invention.

In a general aspect, a computer-implemented method includes receiving a first dataset including a first table having a first number of parts, where each part of the first number of parts represents either a row or a column of the first table and receiving a second dataset including a second table having a second number of parts, where each part of the second number of parts represents either a row or a column of the second table. For each part of the first number of parts the method includes forming a string representation of the part from a number of values associated with the part and determining a numerical representation of the string representation of the part. For each part of the second number of parts, the method includes forming a string representation of the part from a number of values associated with the part and determining a numerical representation of the string representation of the part. The method includes determining a mapping between at least some parts of the first table and second table including determining that a first set of one or more parts of the first number of parts correspond a second set of one or more parts of the second number of parts based at least in part on a similarity between numerical representations of the parts.

Aspects may include one or more of the following features.

Forming a string representation of the part may include converting each value of the number of values to a string representation of the value. Forming a string representation of the part may further include determining a number of character n-grams for the string representation of the value. At least some of the number of character n-grams may be overlapping. Determining the numerical representation may include using a term frequency-inverse document frequency technique. The numerical representation may include a vector representation. The similarity between numerical representations of the parts may include a cosine similarity.

Determining that a first set of one or more parts of the first number of parts correspond a second set of one or more parts of the second number of parts may include applying a random forest classifier to the numerical representations of the parts. The method may include receiving user feedback related to the mapping between the parts of the first table and the second table and training a classifier based at least in part on the user feedback. The method may also include determining a second mapping between at least some parts of the first table and least some parts of the second table using the classifier. The method may also include determining a second mapping between at least some parts of a third table and at least some parts of a fourth table using the classifier.

The method may include joining the first table and the second table based at least in part on the mapping. The first number of parts may include a first number of columns and the second number of parts may include a second number of columns. The first table may include a first number of rows and the second table may include a second number of rows. The method may include determining a second mapping between the first number of rows and the second number of rows. The method may include joining the first table and the second table based at least in part on the first mapping and the second mapping.

In another general aspect, a computer-implemented system includes a first input for receiving a first dataset including a first table having a first number of parts, where each part of the first number of parts represents either a row or a column of the first table and a second input for receiving a second dataset including a second table having a second number of parts, where each part of the second number of parts represents either a row or a column of the second table. The system also includes a processor configured to perform the following steps. For each part of the first number of parts, forming a string representation of the part from a number of values associated with the part and determining a numerical representation of the string representation of the part. For each part of the second number of parts, forming a string representation of the part from a number of values associated with the part and determining a numerical representation of the string representation of the part. Determining a mapping between at least some parts of the first table and second table including determining that a first set of one or more parts of the first number of parts correspond a second set of one or more parts of the second number of parts based at least in part on a similarity between numerical representations of the parts.

In another general aspect, software stored in a non-transitory form on a computer-readable medium includes instructions for causing a computing system to receive a first dataset including a first table having a first number of parts, where each part of the first number of parts represents either a row or a column of the first table and receive a second dataset including a second table having a second number of parts, where each part of the second number of parts represents either a row or a column of the second table. For each part of the first number of parts, the software causes the computing system to form a string representation of the part from a number of values associated with the part and determine a numerical representation of the string representation of the part. For each part of the second number of parts, the software causes the computing system to form a string representation of the part from a number of values associated with the part and determine a numerical representation of the string representation of the part. The software then determines a mapping between at least some parts of the first table and second table including determining that a first set of one or more parts of the first number of parts correspond to a second set of one or more parts of the second number of parts based at least in part on a similarity between numerical representations of the parts.

### BRIEF DESCRIPTION OF THE DRAWINGS

For a fuller understanding of the nature and advantages of the concepts disclosed herein, reference is made to the detailed description of preferred embodiments and the accompanying drawings.

FIG. 1 is a flow chart of a computer-implemented method for unsupervised dataset joining, merging, and/or matching according to an embodiment.

FIG. 2 illustrates an example pair of input datasets or tables according to an embodiment.

FIG. 3 is a flow chart of a computer-implemented method for performing column discovery on input datasets according to an embodiment.

FIG. 4A illustrates an example of datasets values of columns that are converted to text strings.

FIG. 4B illustrates an example of converting the text strings illustrated in FIG. 4A to lower-case text strings.

FIG. 5 illustrates an example of converting the lower-case text strings illustrated in FIG. 4B to a series of n-grams.

FIG. 6 illustrates an example of concatenating the n-grams illustrated in FIG. 5 along a respective column dimension.

FIG. 7 illustrates an example block diagram of training and fitting a word vectorizer model to perform column discovery according to an embodiment.

FIG. 8A illustrates an example similarity matrix according to an embodiment.

FIG. 8B illustrates an example column map or index according to an embodiment.

FIG. 8C illustrates an example column map or index according to another embodiment.

FIG. 9 is a block diagram of computer processors for performing column discovery according to an embodiment.

FIG. 10 is a flow chart of a computer-implemented method for performing row discovery in a dataset according to an embodiment.

FIG. 11 illustrates an example of concatenating the n-grams illustrated in FIG. 5 along a respective row dimension.

FIG. 12 illustrates an example block diagram of training and fitting a word vectorizer model to perform row discovery according to an embodiment.

FIG. 13 is a block diagram of training an approximate nearest neighbor index according to an embodiment.

FIG. 14 is a block diagram of computer processors for performing row discovery according to an embodiment.

FIG. 15 illustrates an example output table according to an embodiment.

FIG. 16 is a block diagram of a computer-implemented method for supervised dataset joining, merging, and/or matching using a human-in-the-loop according to another embodiment.

FIG. 17 is a flow chart of a computer-implemented method for unsupervised dataset joining, merging, and/or matching according to another embodiment.

FIG. 18 is a block diagram of a computer system for dataset joining, merging, and/or matching according to an embodiment.

FIG. 19 illustrates an example XML file excerpt that includes identifier attributes according to an embodiment.

FIG. 20 is a schematic block diagram of a column mapping system.

FIG. 21 is a schematic block diagram of an unsupervised row mapping system.

FIG. 22 is a schematic block diagram of a training step of a supervised row mapping system.

FIG. 23 is a schematic block diagram of a runtime step of a supervised row mapping system.

### DETAILED DESCRIPTION

Column discovery and row discovery are performed, in a computer-implemented method, on input datasets using trained machine-learning models to produce indices of the respective columns and respective rows from each input dataset that are matches or similar to one another. The input datasets are merged or joined using the indices.

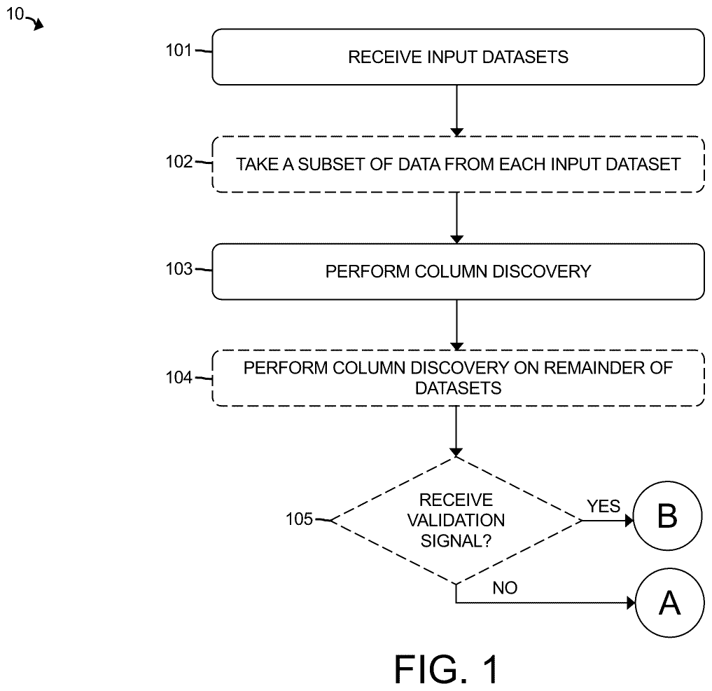

FIG. 1 is a flow chart of a computer-implemented method 10 for unsupervised dataset joining, merging, and/or matching according to an embodiment. In step 101, two or more input datasets are received. The input datasets can include tables, databases, spreadsheets, lists, data files (e.g., comma-separated value (CSV) files, extensible markup language (XML) files, JavaScript Object Notation (JSON) files, etc.), and/or other datasets. The input datasets can have the same format, different formats, or a combination thereof. One or more subsets or “columns” of data in each input dataset has/have the same or similar data, but there may be differences between the data and/or column headings that prevent the columns from being joined, merged, and/or matched using existing methods.

It is noted that a “column” of data is used as shorthand for the conceptual organization of data stored in tables, spreadsheets, databases, and/or other datasets. For example, a column of data can represent a grouping of data using a common key. Embodiments of the invention are applicable and generalizable to other conceptual organizations of data, such as data organized in rows, data organized in multi-dimensional data structures, or data organized in other structures or arrangements. Therefore, discussions or illustrations showing rows, columns, or similar visual or conceptual depictions are made in that spirit where one of skill in the art will understand the generalization of these concepts to actual computer-based data storage and processing systems and methods.

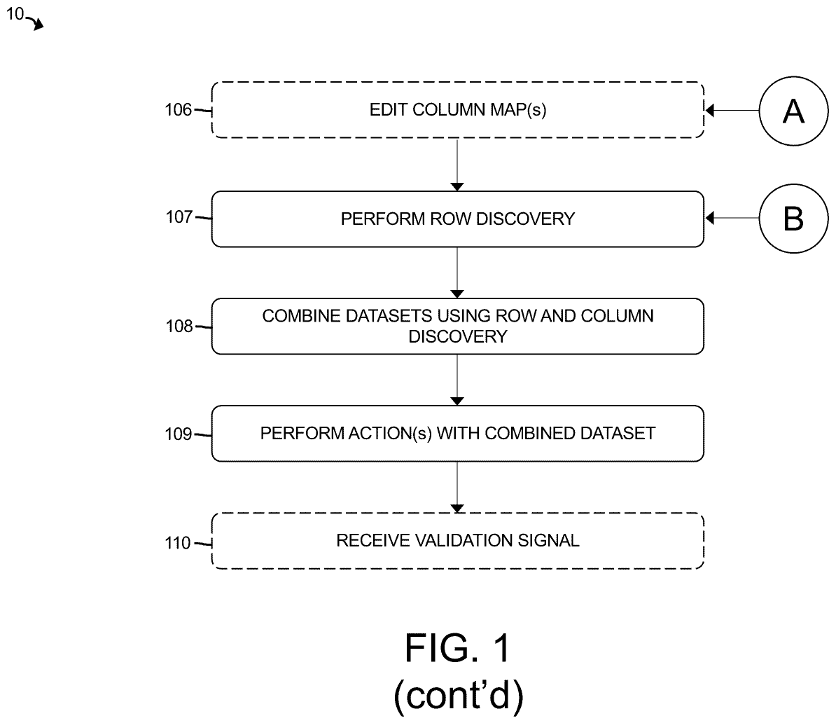

FIG. 2 illustrates an example pair of input datasets or tables 20 and 22 according to an embodiment. The horizontal dashed lines 210 indicate related rows of the tables 20, 22 and show how the content of the rows can be challenging to match using simple methods employed in the prior art. For example, the first table 20 includes a first column 201 titled “First’ that includes the first names of multiple people and a second column 202 titled “Last” that includes the respective last names of multiple people, while the second table 22 includes a first column 221 titled “Name” that includes the first and last names of multiple people with a comma separating the first and second name of each person in a given row. The first and last names in column 201 and 202, respectively, are in capital letters, while only the first letter of the first and last names of each person is capitalized in column 221. In addition, the first table 20 includes a third column 203 titled “Postal Code” with a six-digit number in each row while the second table 22 includes a second column 222 titled “Postalcode” with two three-digit numbers separated by a dash.

In optional step 102, a subset of data is taken from each input dataset. The subset of data can be a random sampling of columns from each input dataset. When input datasets are not in the form of a table, the columns can be identified as a grouping of data using a common key or identifier. Step 102 can be performed when the input datasets are large and there is insufficient memory (e.g., random-access memory (RAM)) in the computer to perform column discovery using all data in the input datasets.

In step 103, column discovery is performed on the data subsets taken in optional step 102. When step 102 is not performed, column discovery is performed on all data in the input datasets. In column discovery, the computer produces a column map that represents the likelihood that there is a relationship or a similarity between one or more columns from each input dataset. The likelihood can be expressed quantitatively such as a similarity metric, a confidence value, and/or another quantitative value (in general, similarity metric). The similarity metric can be compared with a threshold similarity metric to determine whether the columns are similar or dissimilar.

The discovered columns for each dataset can be graphically presented (e.g., on a display screen that is electrically coupled to the computer) to a human operator who can validate or reject the discovered columns. The graphical presentation to the user can include the column map (e.g., similarity metric(s)) and can optionally include the column(s) from each input dataset that were analyzed during column discovery. Alternatively, a link can be provided to the column(s) from each input dataset that were analyzed during column discovery.

When column discovery in step 103 is performed on the data subsets taken in optional step 102, the method proceeds to optional step 104 where column discovery is performed on the remainder of the input datasets. Optional step 104 is performed if/when optional step 102 is also performed (e.g., if a subset of data is taken from each input dataset in optional step 102, the remainder of the data is taken from each input dataset in optional step 102). Optional step 104 is performed in the same manner as step 103.

When an optional rejection signal is received (optional step 105=no), a human operator (e.g., a human in the loop) can optionally manually edit the column map (e.g., by providing one or more column-edit input signals) in optional step 106 (via placeholder A). For example, when the column map includes a high similarity metric that indicates that two columns match, the human operator can manually lower the similarity metric for those two columns to indicate that they do not match. Alternatively, the human operator can delete or remove the mapping between the two columns without adjusting the similarity metric. Conversely, when the column map includes a low similarity metric that indicates that two columns do not match, the human operator can manually increase the similarity metric for those two columns to indicate that they do match. Alternatively, the human operator can add a mapping between the two columns without adjusting the similarity metric.

After column discovery is edited in optional step 106, after an optional validation signal is received (optional step 105=yes), or after step 103 (if optional steps 104-106 are not performed, the method 10 proceeds to step 107. The method proceeds from optional step 105=yes or from step 103 to step 107 via placeholder B. In step 107, row discovery is performed on the input datasets. In row discovery, the computer produces a row map that represents the likelihood (e.g., using a similarity metric or another quantitative metric) that there is a relationship or a similarity between the data values in each row of the input datasets according to the column maps.

In step 108, the input datasets are merged or combined using the row and column discovery where the column discovery is provided as input to the row discovery. The output of step 108 is a merged or combined dataset.

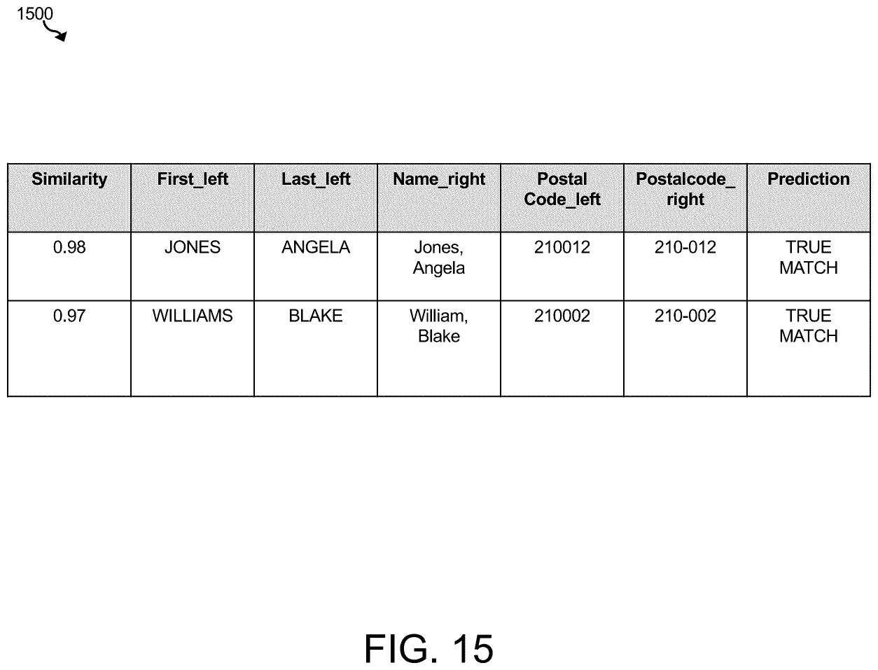

In step 109, the computer performs one or more actions with the combined dataset. For example, the computer can store the combined dataset in computer memory that is operably coupled to the computer. In another example, the computer can display the combined dataset (e.g., on the display screen). In some embodiments, the merged/combined dataset can be displayed with a confidence/similarity score of the model in the prediction and the prediction value (match or no match) from the machine learning model, such as table 1500 in FIG. 15. The computer can optionally prompt the user for feedback, such as to edit the columns and/or rows in the combined dataset.

In optional step 110, a validation signal (or a rejection signal) can be received regarding the merged/combined dataset. A rejection signal can cause received for certain row and/or column matches, which can cause the computer to remove the rejected column(s) and/or row(s) from the final merged/combined dataset. The computer can store the merged/combined dataset in computer memory when the validation signal is received.

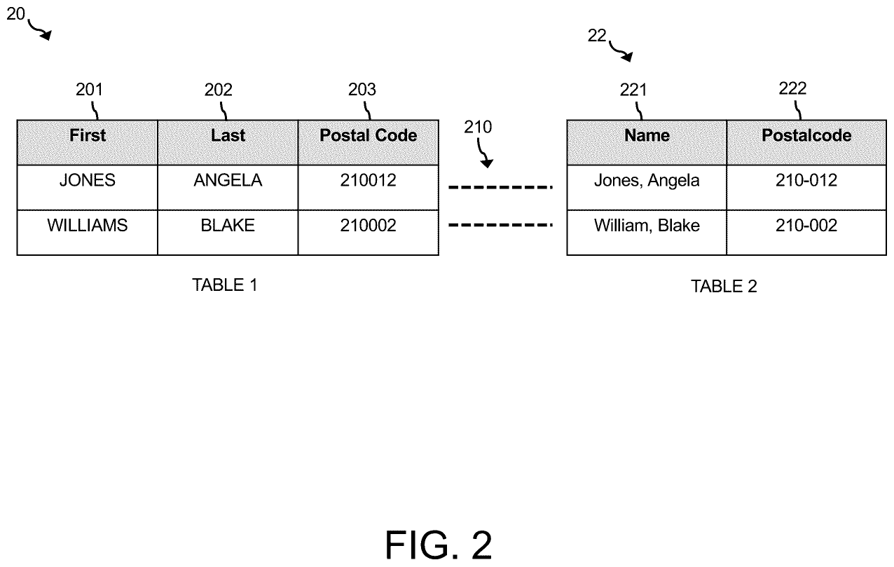

FIG. 3 is a flow chart of a computer-implemented method 30 for performing column discovery on input datasets according to an embodiment. Steps 103 and 106 can be performed using method 30.

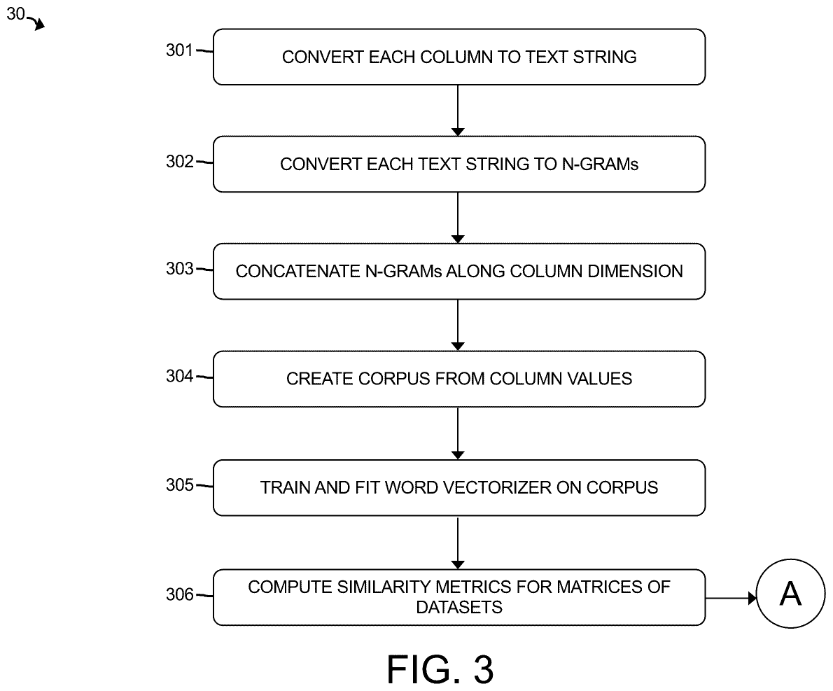

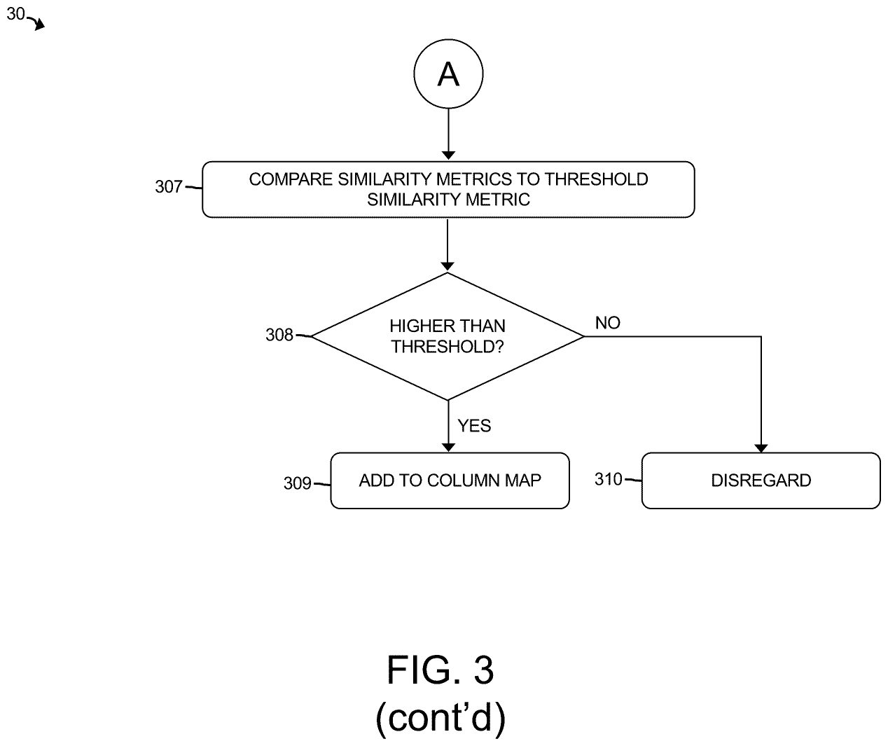

In step 301, the values of each column are converted to a text string. Each text string can be converted to lower-case letters. An example of the output of step 301 is illustrated in FIGS. 4A and 4B. Using the first and second tables 20, 22 as an example, the values of each column are converted to text strings in FIG. 4A. The column headers can optionally be converted to text strings in step 301. The text strings in each table 20, 22 are converted to fully lower-case text strings in FIG. 4B.

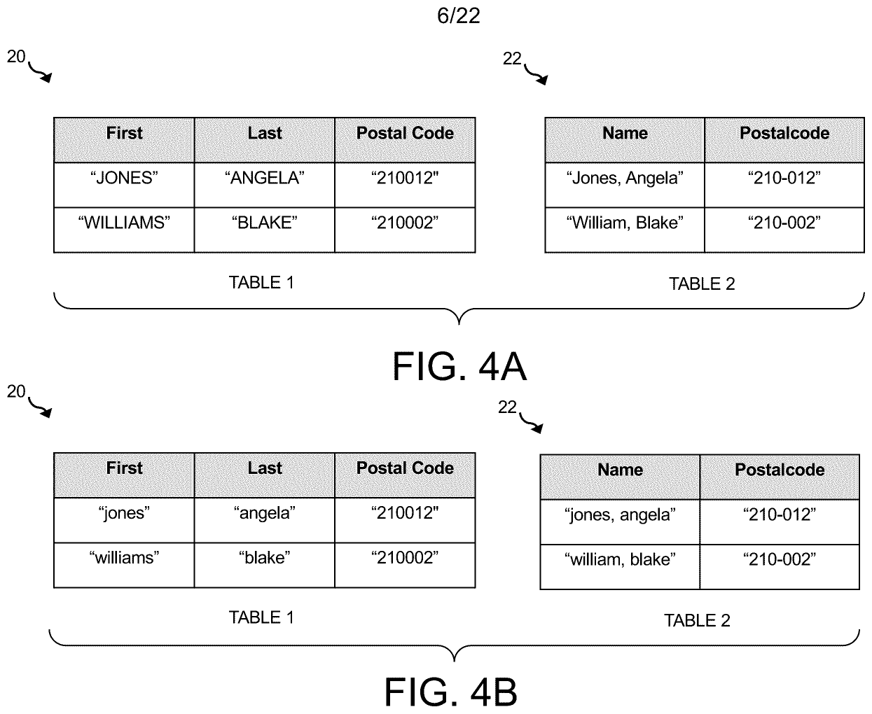

In step 302, each text string is converted into one or more n-grams. An n-gram is a group of n-characters long sequences of a word where n is an integer greater than or equal to 2. An example of the output of step 302 as applied to tables 20, 22 is illustrated in FIG. 5 where n is equal to 3.

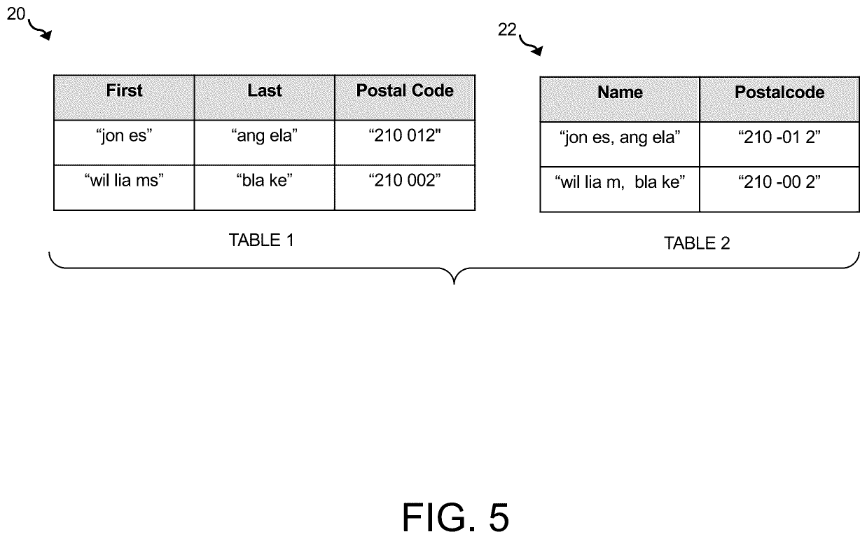

In step 303, the n-grams are concatenated along the column dimension. An example of the output of step 303 as applied to tables 20, 22 is illustrated in FIG. 6 where the n-grams in a given column are combined or concatenated along the column dimension (e.g., compared to FIG. 5). Each column in tables 20, 22 has only one row with the value of the row equal to the concatenated n-grams for the respective column.

In step 304, a corpus of n-grams is created. The corpus of n-grams includes the concatenated n-grams from each column for both datasets. For example, the values of the rows in each table, from the output of step 303, can be concatenated with a comma (or another character) separating each column of concatenated n-grams. An example corpus for tables 20, 22 is {“jon es” “wil lia ms”, “ang ela” “bla ke”, “210 012” “210 002”, “jon es, ang ela” “wil lia m, bla ke”, “210-01 2” “210-00 2”} where a comma between the closed and open quotation marks indicates a different column. The data from each table does not need to be separated in this step.

In step 305, a word vectorizer (e.g., a word-level embedding model is created using machine learning. Example of machine learning include neural networks, traditional machine learning techniques, and/or other methods. The word vectorizer is trained and fit on the n-gram corpus (formed in step 304). The trained word vectorizer can transform the column-wise n-grams (concatenated n-grams produced in step 303) to produce a vector embedding for the columns of n-grams. The vector embedding represents or captures the distribution of n-grams (or words) present in the column of data. In some embodiments, a dimensionality-reduction model, technique, or method can be trained and fit to reduce the embedding vector size.

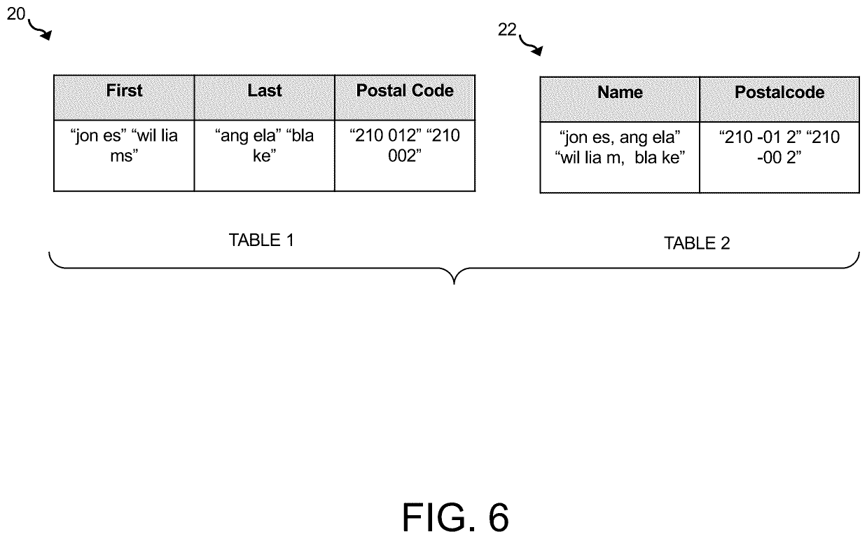

An example of step 305 as applied to tables 20, 22 is illustrated in FIG. 7. The concatenated n-grams of each table 20, 22 are provided as inputs to the trained model 700 (e.g., trained word-level embedding model) that outputs a vector for each column of each table. The vector embedding represents or captures the distribution of n-grams (or words) present in the column of data. For example, the trained model 700 produces three vectors 721 (for columns “First,” “Last,” and “Postal Code”) for the concatenated n-grams from table 20. In addition, the trained model 700 produces two vectors 722 (for columns “Name” and “Postalcode”) for the concatenated n-grams from table 22.

The vectors for each table or dataset can be stacked or combined to form a respective matrix 731, 732 for each table.

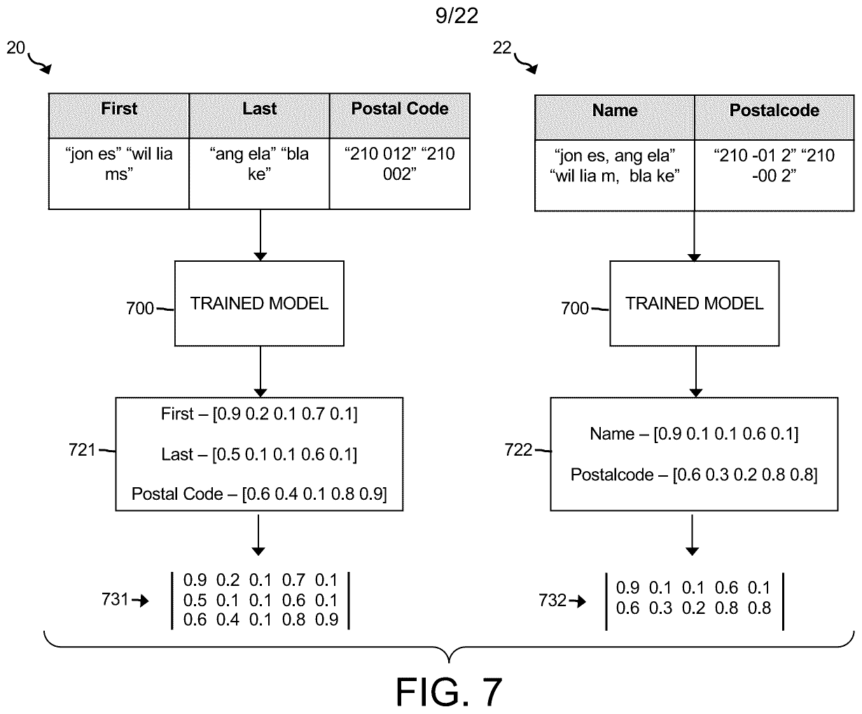

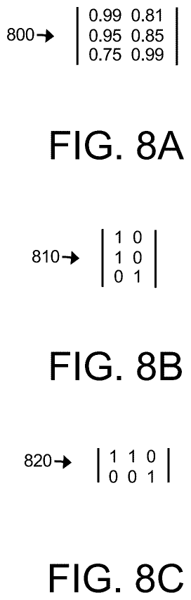

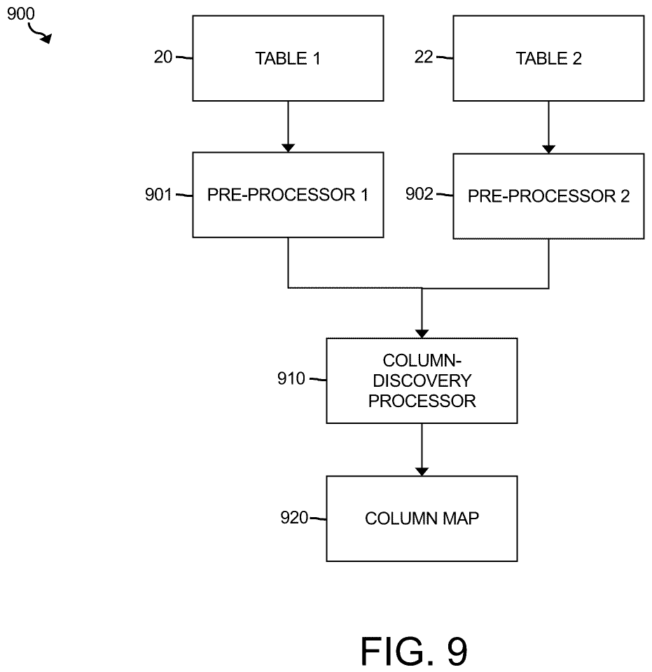

In step 306, similarity metrics are calculated between the matrices formed in step 305. The similarity metric can be or include a cosine similarity between the matrices or vectors. A similarity matrix 800 representing the similarity metrics between matrices 731, 732 is illustrated in FIG. 8A. The values in the similarity matrix 800 represent the similarity between columns from each table 20, 22. For example, the first row corresponds to the “First” column in the first table 20 and the values 0.99 and 0.81 represent the similarity of the “First” column in the first table 20 with “Name” and “Postalcode” columns, respectively, in the second table 22.

In step 307 (via placeholder A), the similarity metrics calculated in step 307 are compared to a threshold similarity metric. For each similarity metric that is higher than the threshold similarity metric (i.e. step 308=yes), the two columns of data that are represented by that similarity metric are added to a column mapping in step 309. The column mapping indicates which column from the first dataset corresponds to or matches which columns (If any) from the second dataset. For each similarity metric that is lower than or equal to the threshold similarity metric (i.e. step 308=no), that similarity metric is disregarded or discarded in step 310 and the column mapping is not modified. Disregarding/discarding the similarity metric indicates that there is no relationship, correspondence, or similarity between the given columns from the first and second datasets. The column mapping can be stored in computer memory operatively coupled to the computer.

In some embodiments, a column map or index 810 can be produced, for example as illustrated in FIG. 8B. The column index can include a “1” for each similarity metric value that is higher than the threshold similarity metric and a “0” for each similarity metric value that is lower than or equal to the threshold similarity metric. In column index 810, each row represents respective columns (“First,” “Last,” “Postal Code”) of the first table 20 and each column represents respective columns (“Name,” “Postalcode”) of the second table 22. The first column of column index 810 is [1, 1, 0] which indicates that the “First” and “Last” columns in the first table 20 correspond to the “Name” column in the second table 22. There is no correlation between the “Postal Code” column in the first table 20 with the “Name” column in the second table 22. The second column of column index 810 is [0, 0, 1] which indicates that the “Postal Code” column in the first table 20 corresponds to the “Postalcode” column in the second table 22. There is no correlation between the “First” and “Last” columns in the first table 20 with the “Postalcode” column in the second table 22. It is noted that if the inputs were reversed (i.e., the inputs were second and first tables 22, 20 instead of first and second tables 20, 22), the resulting output in the column map or index 820, as illustrated in FIG. 8C, would be {“Name”: [“First”, “Last”], “Postalcode”: [“Postal Code”]}. In column index 820, each row represents respective columns (“Name,” “Postalcode”) of the second table 22 and each column represents respective columns (“First,” “Last,” “Postal Code”) of the first table 20.

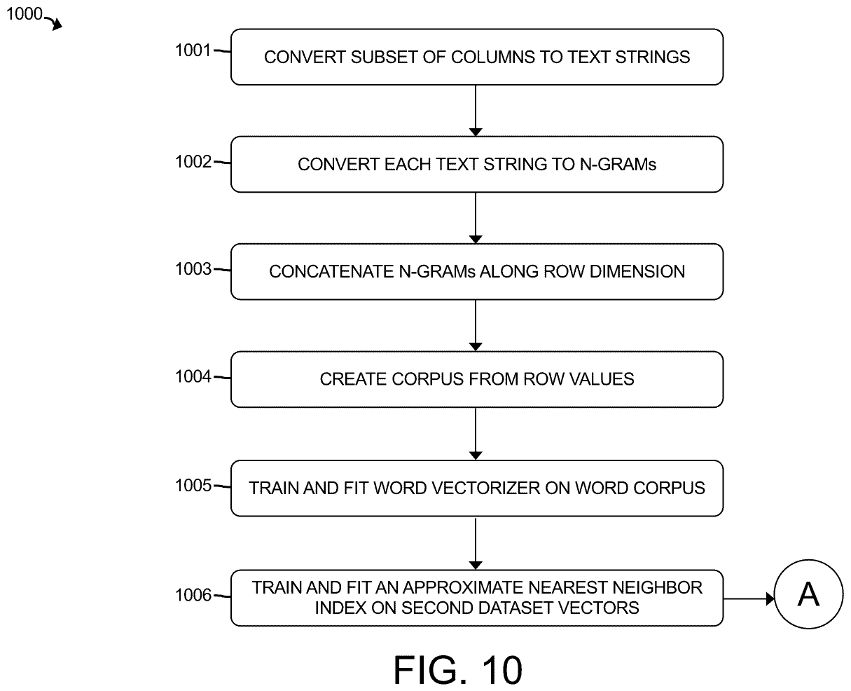

FIG. 9 is a block diagram of computer processors 900 for performing column discovery according to an embodiment. The processors 900 includes first and second pre-processors 901, 902 and a column discovery processor 910. The inputs of the first and second pre-processors 901, 902 receive the first and second tables 20, 22, respectively, and/or other datasets. Each pre-processor 901, 902 is configured to perform steps 301 and 302 on the respective input table 20, 22. For example, pre-processor 901 performs step 301 of converting each column to a text string (e.g., a lower-case text string) and step 302 of converting each text string to a series of n-grams. The output of each pre-processor 901, 902 is a respective n-gram converted table.

The column discovery processor 910 is configured to receive first and second n-gram converted tables that correspond to the first and second tables 20, 22, respectively. The column discovery processor is configured to perform steps 303-310 using the first and second n-gram converted tables. The output of the column discovery processor 910 is a column map 920 that indicates the relationship (if any) and/or similarity between the columns of the input tables/datasets (e.g., first and second tables 20, 22).

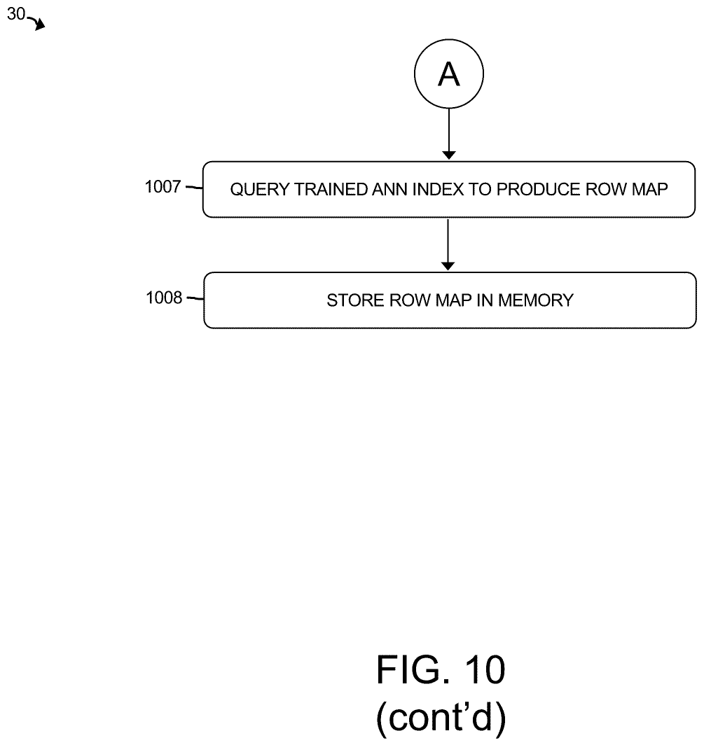

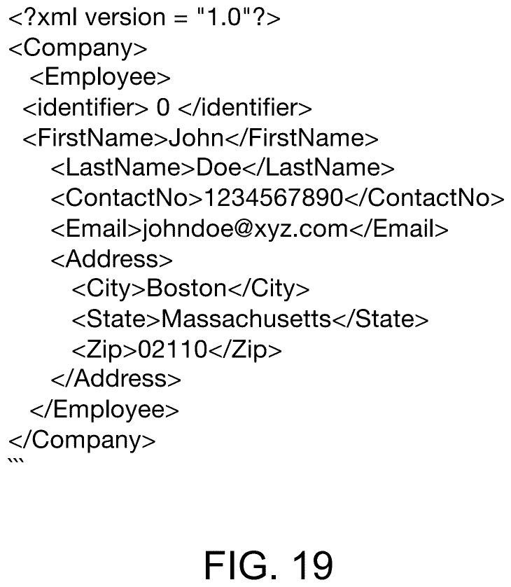

FIG. 10 is a flow chart of a computer-implemented method 1000 for performing row discovery in a dataset according to an embodiment. Step 107 can be performed using method 1000. Rows in datasets that are XML files or databases can be identified by using common identifier attributes. For example, in the XML file excerpt illustrated in FIG. 19, the identifier attributes <FirstName>, <LastName>, <ContactNo>, <Email>, <City>, <State>, and <Zip> can represent columns of data and the data (e.g., Joh, Doe, etc.) can represent the rows of data.

In step 1001, the values of a subset of the columns from each dataset are converted to a text string. Each text string can be converted to lower-case letters.

In step 1002, each text string is converted into one more n-grams. An n-gram is a group of n characters long where n is an integer greater than or equal to 2. The size of the n-grams (value of n) in step 1002 can be the same as or different than size of the n-grams (value of n) in step 302. Steps 1001 and 1002 can be the same as steps 301 and 302, respectively. In some embodiments, the result of steps 301 and 302 can be stored for use in method 1000 in which case steps 1001 and 1002 do not need to be performed.

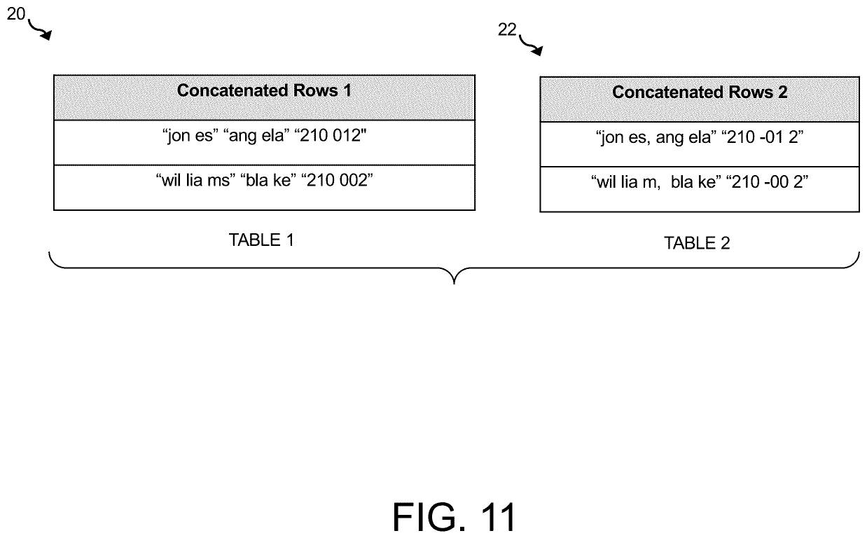

In step 1003, the n-grams are concatenated along the row dimension. An example of the output of step 1003 as applied to tables 20, 22 is illustrated in FIG. 11 where the n-grams in a given row are combined or concatenated along the row dimension (e.g., compared to FIG. 5). Each row in tables 20, 22 has only one column with the value of each row equal to the concatenated n-grams for the respective row.

In step 1004, a corpus of n-grams is created. The corpus of n-grams includes the concatenated n-grams from each column for both datasets. For example, the values of the rows in each table, from the output of step 303, can be concatenated with a comma (or another character) separating each column of concatenated n-grams. An example corpus for tables 20, 22 is {“jon es” “ang ela” “210 012”, “wil lia ms” “bla ke” “210 002”, “jon es, ang ela” “210-01 2”, “wil lia m, bla ke” “210-00 2”} where a comma between the closed and open quotation marks indicates a different row. The corpus does not need to differentiate between the first and second tables 20, 22.

In step 1005, a word vectorizer (e.g., a word-level embedding model is created using machine learning. Example of machine learning include neural networks, traditional machine learning techniques, and/or other methods. The word vectorizer—is trained and fit on the n-gram corpus (formed in step 1104). The trained word vectorizer can transform the column-wise n-grams (concatenated n-grams produced in step 303) to produce a vector embedding for the columns of n-grams. The vector embedding represents or captures the distribution of n-grams (or words) present in the column of data. In some embodiments, a dimensionality-reduction model, technique, or method can be trained and fit to reduce the embedding vector size.

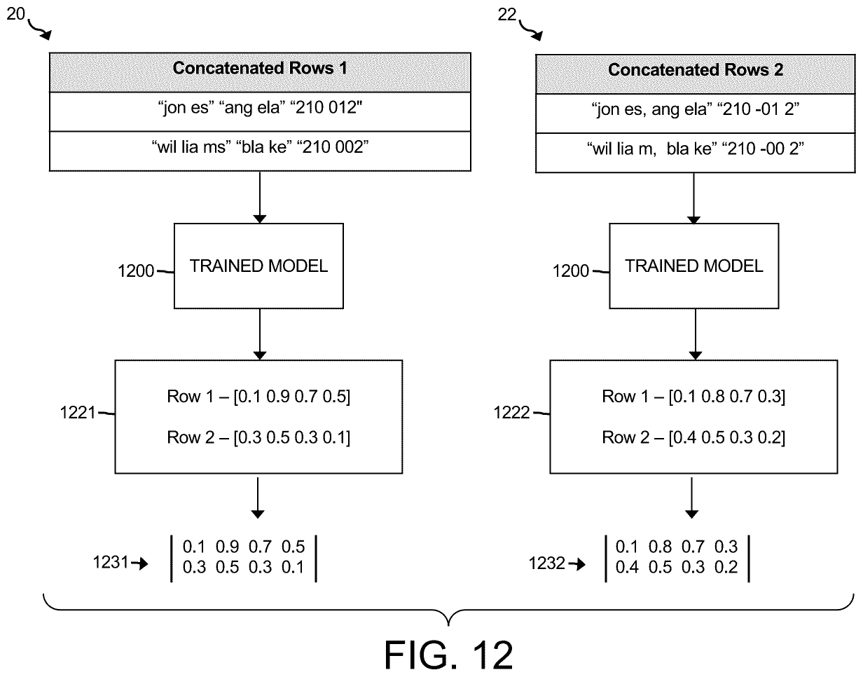

An example of step 1005 as applied to tables 20, 22 is illustrated in FIG. 12. The concatenated n-grams of each table 20, 22 are provided as inputs to the trained machine-learning model 1200 (e.g., a trained vectorizer) that outputs a vector for each row of each table. For example, the trained machine-learning model 1200 produces two vectors 1221 (for each row of concatenated n-grams from table 21) for the concatenated n-grams from table 20. In addition, the trained machine-learning model 1200 produces two vectors 1222 (for each row of concatenated n-grams from table 22) for the concatenated n-grams from table 22. The vectors 1222 for each row represent the distribution of n-grams (or words) present in the respective row.

The vectors for each table or dataset can be stacked or combined to form a respective matrix 1231, 1232 for each table.

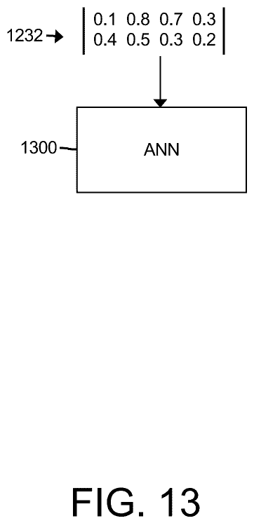

In step 1006, an approximate nearest neighbor (ANN) index is trained with the second dataset vectors or matrix (e.g., matrix 1232). An ANN is a data structure used to efficiently retrieve k-nearest values in vector space to a given query vector. When training an ANN index, a similarity measure (cosine, 12 distance, etc.) and a base data structure are selected (KD-Tree, Ball-tree, etc.). After selection of the similarity measure and the base data structure, the data structure is optimized when inserting the values from the training set to enable fast querying of vectors. An example of training an ANN 1300 using the second matrix 1232 is illustrated in FIG. 13.

In step 1007, the trained ANN index is queried using the first dataset vectors (or matrix (e.g., matrix 1231)) for one for one of the datasets to obtain an index or row map that indicates or predicts the relationship or matches between the rows of each input dataset (e.g., tables 20, 22). An example row index/map for tables 20, 22 is {0:0, 1:1} which indicates that the 0 index (first) row of the first table 20 corresponds to the 0 index (first) row of the second table 22, and that the 1 index (second) row of the first table 20 corresponds to the 1 index (second) row of the second table 22.

In an alternative embodiment, in step 1006 the ANN index can be trained with the first dataset vectors or matrix (e.g., matrix 1231) and in step 1007 the trained ANN index can be queried using the second dataset vectors (or matrix (e.g., matrix 1232)).

In step 1008, the row map/indices can be stored in computer memory operatively coupled to the computer.

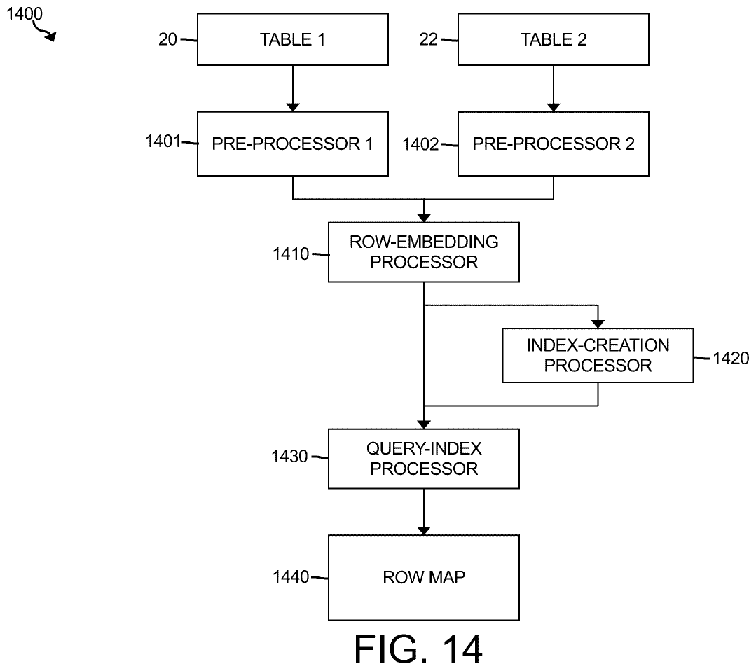

FIG. 14 is a block diagram of computer processors 1400 of a computer for performing row discovery according to an embodiment. The processors 1400 include first and second pre-processors 1401, 1402, a row-embedding processor 1410, and a query-index processor 1420. The inputs of the first and second pre-processors 1401, 1402 receive the first and second tables 20, 22, respectively, and/or other datasets. Each pre-processor 1401, 1402 is configured to perform steps 1001 and 1002 on the respective input table 20, 22. For example, pre-processor 1401 performs step 1001 of converting each column to a text string (e.g., a lower-case text string) and step 1002 of converting each text string to a series of n-grams. The output of each pre-processor 1001, 1002 is a respective n-gram converted table.

The row-embedding processor 1410 is configured to receive as inputs the first and second n-gram converted tables that correspond to the first and second tables 20, 22, respectively. The row-embedding processor 1410 is configured to perform steps 1003-1005 using the first and second n-gram converted tables. The output of the row-embedding processor 1410 includes first and second row-embedding tables that includes a respective vector for each row in the first and second n-gram converted tables, respectively. An example of the first and second row-embedding tables is vectors 1221, 1222 (FIG. 12), respectively.

The index-creation processor 1420 is configured to receive as inputs the vectors or matrix from the second dataset (e.g., vectors 1222 or matrix 1232). The index-creation processor 1420 is configured to perform step 1006 using the vectors or matrix from the second dataset. The output of the index-creation processor 1420 is a trained ANN.

The query-index processor 1430 is configured to receive as inputs the trained ANN from the index-creation processor 1420 and the vectors or matrix from the first dataset (e.g., vectors 1221 or matrix 1231), which is output from the row-embedding processor 1410. The query-index processor 1430 is configured to perform step 1007 and optional step 1008. Step 1007 is performed using the trained ANN and the vectors or matrix from the first dataset.

In an alternative embodiment, the index-creation processor 1420 can be configured to receive as inputs the vectors or matrix from the first dataset (e.g., vectors 1221 or matrix 1231) and perform step 1006 using the vectors or matrix from the first dataset. The query-index processor 1430 can be configured to receive as inputs the trained ANN from the index-creation processor 1420 and the vectors or matrix from the second dataset (e.g., vectors 1222 or matrix 1232), which is output from the row-embedding processor 1410. The query-index processor 1430 can be configured to perform step 1007 using the trained ANN and the vectors or matrix from the second dataset.

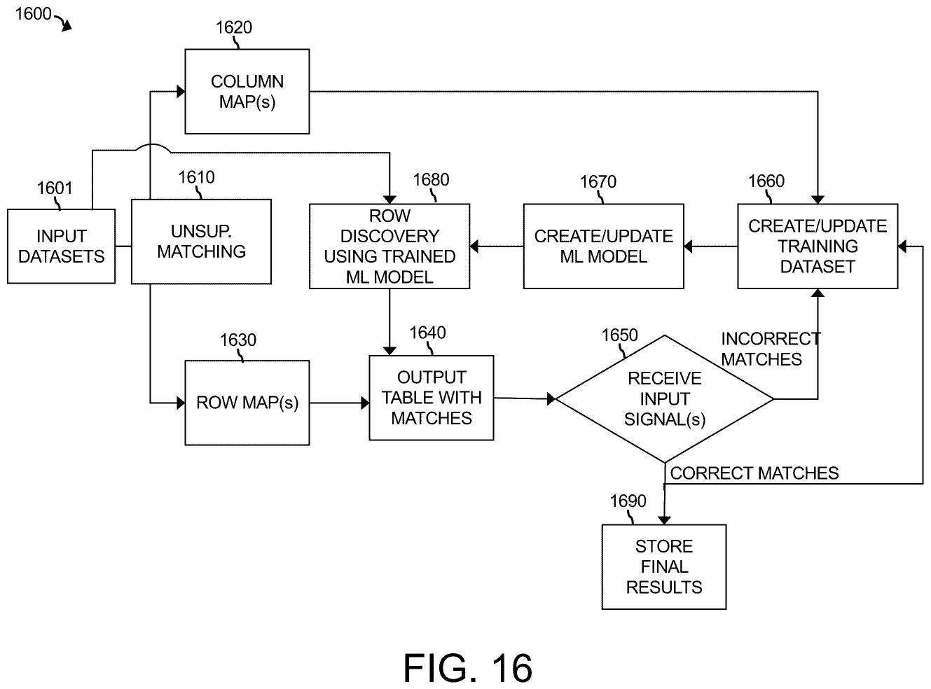

FIG. 16 is a block diagram of a computer-implemented method 1600 for supervised dataset joining, merging, and/or matching using a human-in-the-loop according to another embodiment.

In step 1601, two or more input datasets are received. In step 1610, the rows and columns (or their respective equivalents) from the input datasets are matched in an unsupervised manner, for example according to method 10. The outputs of step 1610 are column map(s)/indices 1620 and row map(s)/indices 1630. The column map(s)/indices 1620 indicate which column(s) in each input dataset appear to be same or similar. The row map(s)/indices 1630 indicate which rows in each input dataset appear to be same or similar. Though human input may have provided to edit the column map(s)/indices 1620 and/or the row map(s)/indices 1630 (e.g., in steps 106 and/or 110 in method 10), method 10 is referred to as unsupervised because human input is not provided to the ML models.

In step 1640, the computer produces and displays an output table that represents some or all of the column and row maps/indices. For example, the output table can include columns and rows from each input datasets and a similarity score regarding the match of each row. The output table can be or appear the same as table 1500.

In step 1650, the computer receives one or more input signals regarding the accuracy of the output table. The input signals can be provided by a human operator of the computer (e.g., as a human-in-the-loop). The input signals can indicate whether any rows from each input dataset are incorrectly identified as potential matches and/or as potential non-matches. The input signals can also indicate whether any rows from each input dataset are correctly identified as potential matches and/or as potential non-matches. The output of step 1650 includes a list of rows that are correctly identified as matches and a list of rows that are incorrectly identified as matches.

In step 1660, the rows that are correctly identified as matches and the rows that are incorrectly identified as matches are used to create a training dataset for a new ML classifier. The training dataset also includes the column map(s) 1620.

In step 1670, a new ML classifier is trained using the training dataset. In 1680, the new ML classifier performs row discovery of the input datasets. After step 1670, the method 10 returns to step 1640 in a second loop where the computer produces and displays an output table that represents some or all of the column and row maps/indices using the row discovery from the new ML classifier.

In step 1650 (in the second loop), the computer receives one or more input signals regarding the accuracy of the output table. In step 1660, The rows that are correctly identified as matches and the rows that are incorrectly identified as matches are used to update the training dataset for the ML classifier. The training dataset also includes the column map(s) 1620.

In step 1670, the ML classifier is updated or retrained using the updated training dataset. In 1680, the updated ML classifier performs row discovery of the input datasets. This loop of steps 1640, 1650, 1660, 1670, and 1680 can continue until the input signals received in step 1650 indicate either (a) that all rows are matched correctly or (b) the user desires to end training of the ML classifier, at which point the final results, including the updated/trained ML classifier, are stored in computer memory. The final results also include the column maps, the row maps, and/or a combined dataset that includes the matched columns and rows.

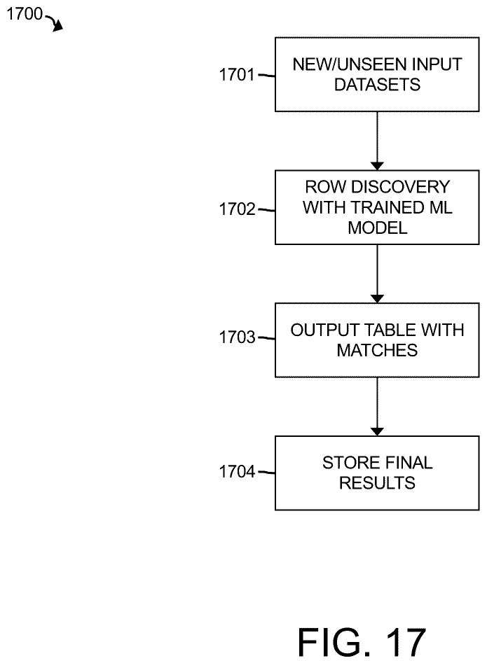

FIG. 17 is a flow chart of a computer-implemented method 1700 for unsupervised dataset joining, merging, and/or matching according to another embodiment.

In step 1701, two or more new/unseen input datasets are received. The input datasets have the same columns as the input datasets used to train the ML classifier in method 1600 (e.g., in step 1670).

In step 1702, row discovery of the new input datasets is performed using the trained ML classifier from method 1600.

In step 1703, the computer produces and displays an output table that represents some or all of the column and row maps/indices. For example, the output table can include columns and rows from each input datasets and a similarity score regarding the match of each row. The output table can be or appear the same as table 1500.

In step 1704, the computer stores the final results in computer memory. The final results can include the column maps, the row maps, and/or a combined dataset that includes the matched columns and rows.

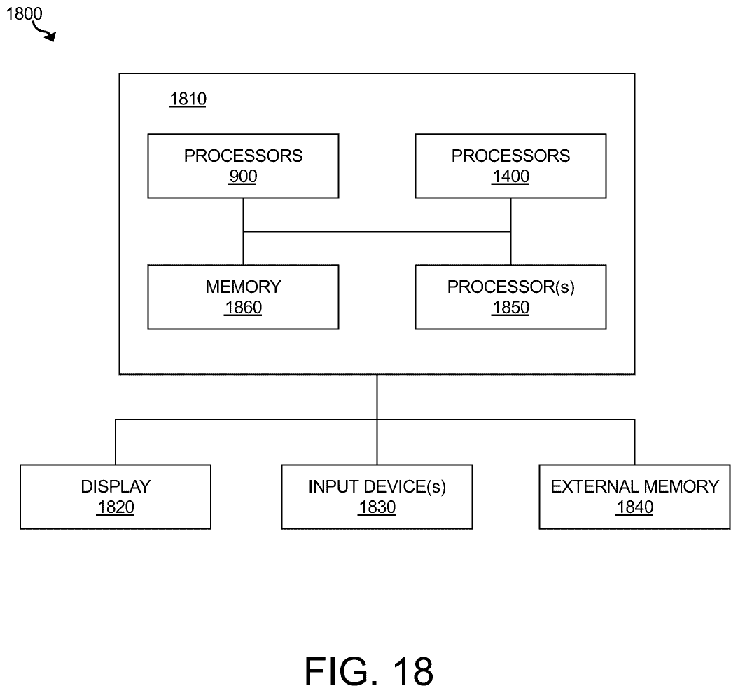

FIG. 18 is a block diagram of a computer system 1800 for dataset joining, merging, and/or matching according to an embodiment. The computer system 1800 includes a computer 1810, a display 1820, one or more input devices 1830, and an optional external memory 1840.

The computer 1810 includes the processors 900 (FIG. 9) for performing column discovery and the processors 1400 (FIG. 14) for performing row discovery. The computer 1810 can also include one or more additional processors 1850, such as one or more microprocessors, central processing units (CPUs), graphics processing units (GPUs), and/or other hardware processors. The processors 900, 1400, and 1850 can be in electrical communication with each other. In addition, The processors 900, 1400, and 1850 are in electrical communication with computer memory 1860 which can include non-volatile computer memory. The computer memory 1860 stores computer-readable instructions that cause the processors 900, 1400, and/or 1850 to perform the methods or one or more steps of the methods described herein (e.g., methods 10, 30, and/or 1000).

The display 1820 is electrically coupled to the computer 1810. The computer 1810 can cause the display 1820 to display graphics and/or text such as the input datasets, the combined datasets, and/or other graphics and/or text relating to the methods described herein. The computer 1810 can further cause the display 1820 to display a user interface, such as a graphical user interface, that allows a user to interact with the computer 1810 using one or more input device(s) 1830, which can include a mouse, a keyboard, a touchscreen, and/or other computer input devices.

The optional external memory 1840 can include a computer program product such as a non-transitory computer readable storage media. The external memory 1840 can store computer-readable instructions that cause the processors 900, 1400, and/or 1850 to perform the methods or one or more steps of the methods described herein (e.g., methods 10, 30, and/or 1000). Thus, the computer-readable instructions can be stored in computer memory 1860 and/or in external memory 1840.

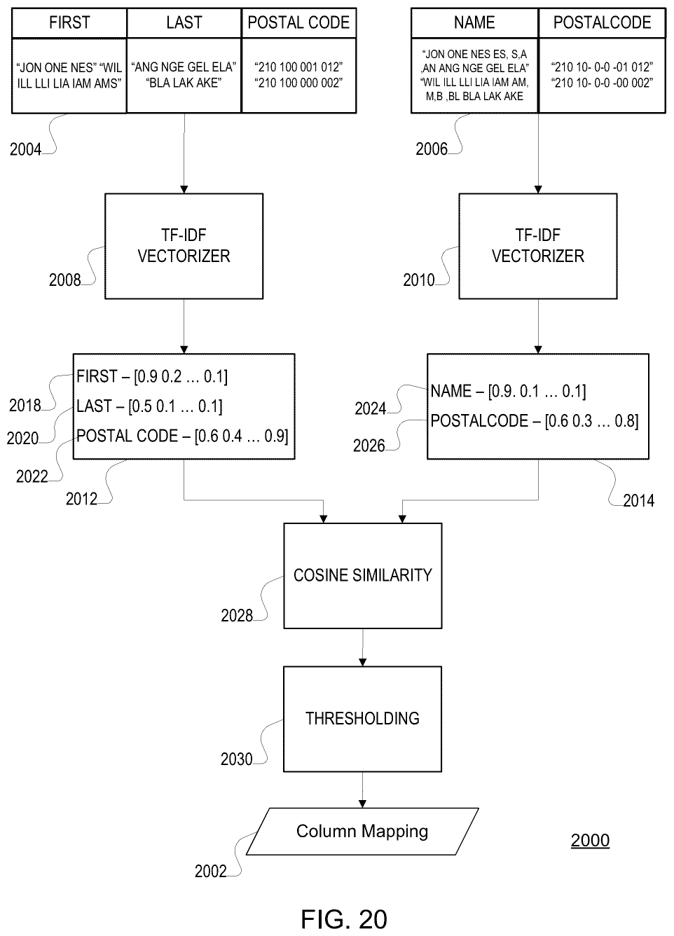

Referring to FIG. 20, in another example, a column mapping system 2000 processes input datasets including tables (e.g., the tables of FIG. 2) to determine a column mapping 2002 between the tables. Like the examples described above, for each column in the tables, the values for each row of the column are first converted to strings of lower-case letters and concatenated. The result is one string for each column of each table.

Each string is then converted into a set of one or more n-grams. The result is an n-gram representation of the first table 2004 and an n-gram representation of the second table 2006 (where both n-gram representations are 3-gram representations in this example). In the examples described above, the n-grams were non-overlapping. In this example, the n-gram representations of strings are overlapping (i.e., “angela” becomes “ang nge gel ela”). In some examples, a parameter allows a user to specify whether the n-gram representations are overlapping or non-overlapping.

The n-gram representation of the first table 2004 and the n-gram representation of the second table 2006 are provided to respective term frequency-inverse document frequency (TF-IDF) vectorizers 2008, 2010 that are fitted to the input datasets. The TF-IDF vectorizers process the strings of n-grams for each column to generate corresponding vector representations 2012, 2014 of the strings. In some examples, the TF-IDF vectorizers operate by calculating the Term Frequency (TF) of each term (e.g., each 3-gram) within a string, representing the frequency of occurrence. The TF-IDF vectorizers also calculate the Inverse Document Frequency (IDF) for the term, which represents the rarity of the term across the entire corpus or input datasets (e.g., all the strings). These values are then combined to obtain the TF-IDF “score” (e.g., a value from 0.0 to 0.1) for each term. The vector representation for a particular column includes the scores for all terms and characterizes the column in a high-dimensional space. In some embodiments, a dimensionality-reduction model, technique, or method can be trained and fit to reduce the size of the vector representations of the columns.

In the example of FIG. 20, the vector representations 2012 of the columns in the first table include a first vector 2018 for the “FIRST” column, a second vector 2020 for the “LAST” column, and a third vector 2022 for the “POSTAL CODE” column. Similarly, the vector representations 2014 of the columns in the second table include a fourth vector 2024 for the “NAME” column and a fifth vector 2026 for the “POSTALCODE” column.

The vector representations 2012, 2014 of the columns in the tables are provided to a cosine similarity module 2028, which generates a similarity matrix representing a similarity between the columns of the two tables (as is described above with reference to FIG. 8A). The similarity matrix is then processed in a thresholding module 2030 that applies a similarity threshold to determine the column mapping 2002 (as described above with reference to FIG. 8B).

In some examples, the column mapping 2002 is presented to a user for confirmation and/or modification of the mapping. Furthermore, in some examples, a user can pre-map some of the columns in the tables (e.g., columns that are clearly equivalent to the user) to improve the column mapping 2002 that is ultimately generated.

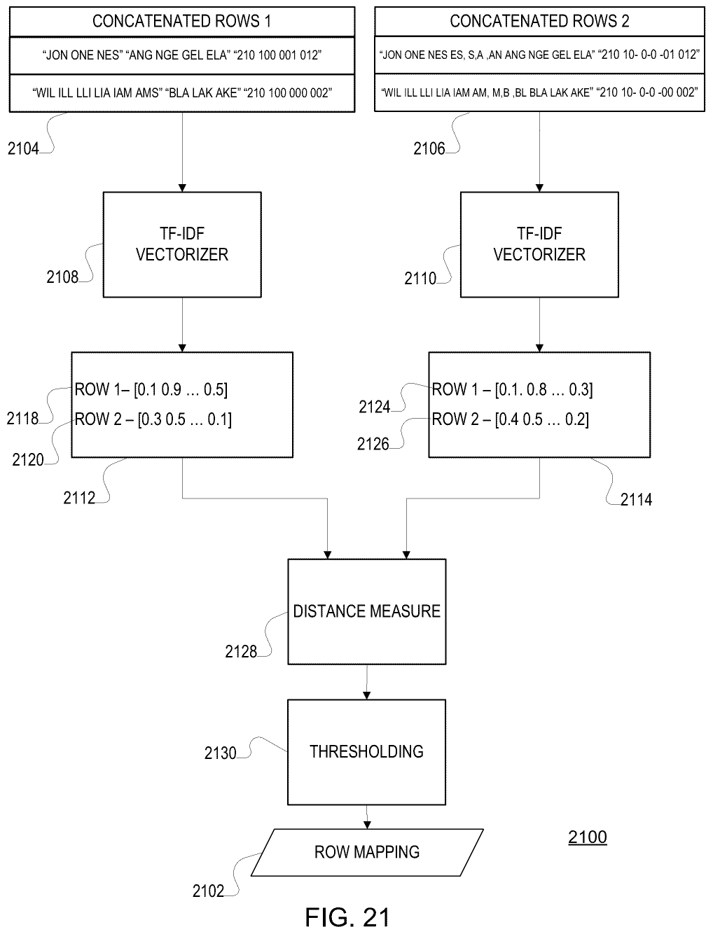

Referring to FIG. 21, an unsupervised row mapping system 2100 is configured to process input datasets or tables (e.g., the tables of FIG. 2) to determine a row mapping 2102 between the tables in an unsupervised manner.

In some examples, the row mapping system 2100 uses only columns that were successfully mapped between the input tables (e.g., from the column mapping 2002). Like in the examples described above, for each row in the tables, the values in the successfully mapped columns are converted to strings of lower-case letters and concatenated. The result is one string for each row of each table.

The string for each row is then converted to a set of one or more n-grams. The result is an n-gram representation of the first table 2104 and an n-gram representation of the second table 2106 (where both n-gram representations are 3-gram representations in this example). Again, the n-gram representations of the strings may be overlapping or non-overlapping.

The n-gram representation of the first table 2104 and the n-gram representation of the second table 2106 are provided to respective term frequency-inverse document frequency (TF-IDF) vectorizers 2108, 2110. As in the case above, the TF-IDF vectorizers process the strings of n-grams for each row to generate corresponding vector representations 2112, 2114 of the strings. In some embodiments, a dimensionality-reduction model, technique, or method can be trained and fit to reduce the size of the vector representations of the columns.

In the example of FIG. 21, the vector representations 2112 of the rows in the first table include a first vector 2118 for “ROW 1” and a second vector 2120 for “ROW 2” of the first table. Similarly, the vector representations 2114 of the rows in the second table include a fourth vector 2124 for “ROW 1” of the second table and a fifth vector 2126 for “ROW 2” of the second table.

The vector representations of the rows in the tables 2112, 2114 are provided to a distance measure module 2128, which generates a similarity matrix representing a similarity between the columns of the two tables (e.g., using a cosine similarity measure is described above with reference to FIG. 8A). The similarity matrix is then processed in a thresholding module 2130 that applies a similarity threshold to determine the row mapping 2102 (as described above with reference to FIG. 8B). In other examples, alternative approaches such as an approximate nearest neighbor approach (as described above with reference to FIGS. 12 and 13) can be used to determine the row mapping 2102.

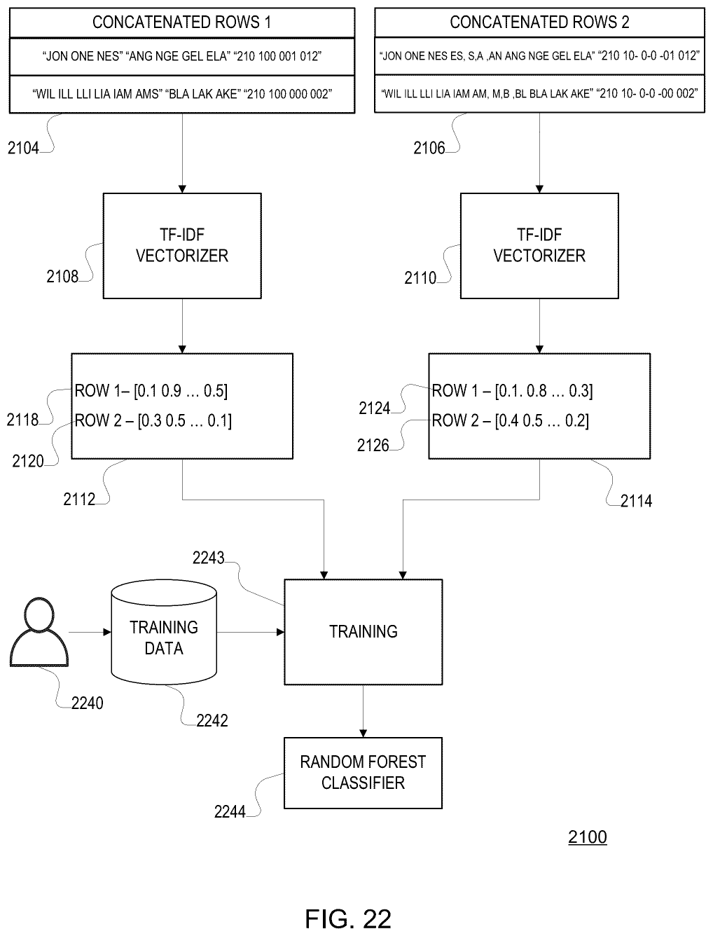

Referring to FIG. 22, in some examples, the row mapping 2102 is provided to a user 2240, who provides feedback to identify which row mappings are incorrect and/or which row mappings are correct. That feedback is included in training data 2242 that is used by a training module 2243 to train a classifier such as a random forest classifier 2244 (e.g., scikit learn's random forest classifier). In some examples, the training data 2242 includes features including pairs of transformed n-grams and their associated similarity and labels including the candidate row matches in the row mapping 2102 from the unsupervised row mapping and row matches from the user feedback described above.

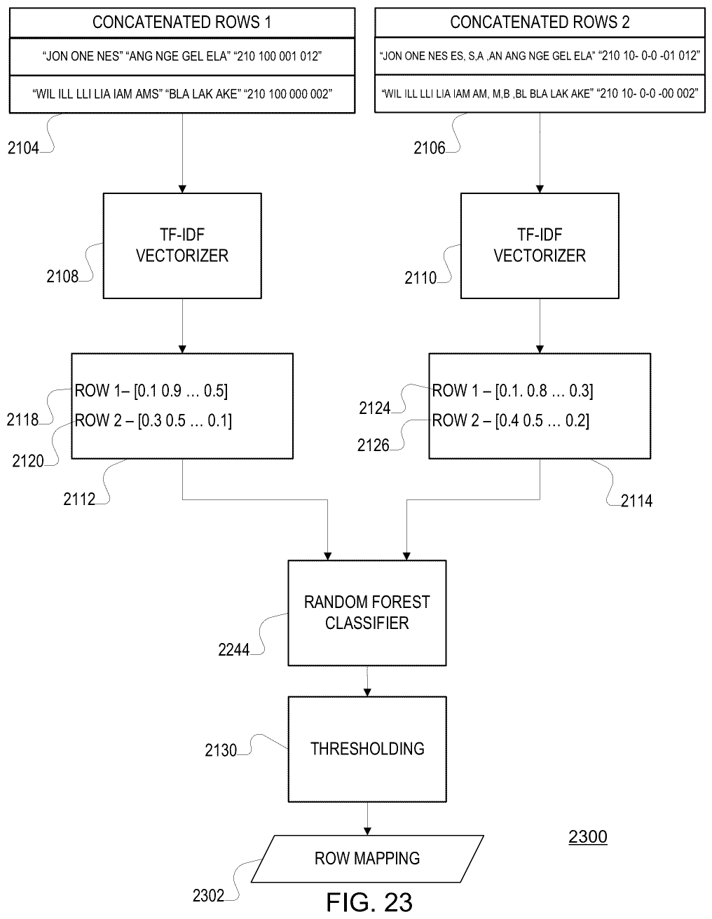

Referring to FIG. 23, the random forest classifier 2244 trained in FIG. 22 can be used during runtime to determine similarity measures between rows from the different tables. For example, the random forest classifier 2244 receives the vector representations 2112 of the rows in the first table and the vector representations 2114 of the rows in the second table as input and generates matches between the rows, where each match is associated with a match probability. The match probabilities are used to build a similarity matrix that is processed in the thresholding module 2130, which applies a similarity threshold to determine the row mapping 2302.

The invention should not be considered limited to the particular embodiments described above. Various modifications, equivalent processes, as well as numerous structures to which the invention may be applicable, will be readily apparent to those skilled in the art to which the invention is directed upon review of this disclosure. The above-described embodiments may be implemented in numerous ways. One or more aspects and embodiments involving the performance of processes or methods may utilize program instructions executable by a device (e.g., a computer, a processor, or other device) to perform, or control performance of, the processes or methods.

In this respect, various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the aspects described above. In some embodiments, computer readable media may be non-transitory media.

The terms “program,” “app,” and “software” are used herein in a generic sense to refer to any type of computer code or set of computer-executable instructions that may be employed to program a computer or other processor to implement various aspects as described above. Additionally, it should be appreciated that, according to one aspect, one or more computer programs that when executed perform methods of this application need not reside on a single computer or processor but may be distributed in a modular fashion among a number of different computers or processors to implement various aspects of this application.

Computer-executable instructions may be in many forms, such as program modules, executed by one or more computers or other devices. Generally, program modules include routines, programs, objects, components, data structures, etc. that performs particular tasks or implement particular abstract data types. The functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Thus, the disclosure and claims include new and novel improvements to existing methods and technologies, which were not previously known nor implemented to achieve the useful results described above. Users of the method and system will reap tangible benefits from the functions now made possible on account of the specific modifications described herein causing the effects in the system and its outputs to its users. It is expected that significantly improved operations can be achieved upon implementation of the claimed invention, using the technical components recited herein.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A computer-implemented method comprising:
receiving a first dataset including a first table having a first plurality of parts, where each part of the first plurality of parts represents either a row or a column of the first table;
receiving a second dataset including a second table having a second plurality of parts, where each part of the second plurality of parts represents either a row or a column of the second table;
for each part of the first plurality of parts,
forming a string representation of the part from a plurality of values associated with the part; and
determining a numerical representation of the string representation of the part;
for each part of the second plurality of parts,
forming a string representation of the part from a plurality of values associated with the part; and
determining a numerical representation of the string representation of the part;
determining a mapping between at least some parts of the first table and second table including determining that a first set of one or more parts of the first plurality of parts correspond a second set of one or more parts of the second plurality of parts based at least in part on a similarity between numerical representations of the parts.

2. The method of claim 1 wherein forming a string representation of the part includes converting each value of the plurality of values to a string representation of the value.

3. The method of claim 2 wherein forming a string representation of the part further includes determining a plurality of character n-grams for the string representation of the value.

4. The method of claim 3 wherein at least some of the plurality of character n-grams are overlapping.

5. The method of claim 1 wherein determining the numerical representation includes using a term frequency-inverse document frequency technique.

6. The method of claim 5 wherein the numerical representation includes a vector representation.

7. The method of claim 1 wherein the similarity between numerical representations of the parts includes a cosine similarity.

8. The method of claim 1 wherein determining that a first set of one or more parts of the first plurality of parts correspond a second set of one or more parts of the second plurality of parts includes applying a random forest classifier to the numerical representations of the parts.

9. The method of claim 1 further comprising receiving user feedback related to the mapping between the parts of the first table and the second table and training a classifier based at least in part on the user feedback.

10. The method of claim 9 further comprising determining a second mapping between at least some parts of the first table and least some parts of the second table using the classifier.

11. The method of claim 9 further comprising determining a second mapping between at least some parts of a third table and at least some parts of a fourth table using the classifier.

12. The method of claim 1 further comprising joining the first table and the second table based at least in part on the mapping.

13. The method of claim 1 wherein the first plurality of parts includes a first plurality of columns and the second plurality of parts includes a second plurality of columns.

14. The method of claim 13 wherein the first table includes a first plurality of rows and the second table includes a second plurality of rows.

15. The method of claim 14 further comprising determining a second mapping between the first plurality of rows and the second plurality of rows.

16. The method of claim 15 further comprising joining the first table and the second table based at least in part on the first mapping and the second mapping.

17. A computer-implemented system comprising:
a first input for receiving a first dataset including a first table having a first plurality of parts, where each part of the first plurality of parts represents either a row or a column of the first table;
a second input for receiving a second dataset including a second table having a second plurality of parts, where each part of the second plurality of parts represents either a row or a column of the second table;
a processor configured to perform the following steps:
for each part of the first plurality of parts,
forming a string representation of the part from a plurality of values associated with the part;
determining a numerical representation of the string representation of the part;
for each part of the second plurality of parts,
forming a string representation of the part from a plurality of values associated with the part;
determining a numerical representation of the string representation of the part;
determining a mapping between at least some parts of the first table and second table including determining that a first set of one or more parts of the first plurality of parts correspond a second set of one or more parts of the second plurality of parts based at least in part on a similarity between numerical representations of the parts.

18. Software stored in a non-transitory form on a computer-readable medium, the software including instructions for causing a computing system to:
receive a first dataset including a first table having a first plurality of parts, where each part of the first plurality of parts represents either a row or a column of the first table;
receive a second dataset including a second table having a second plurality of parts, where each part of the second plurality of parts represents either a row or a column of the second table;
for each part of the first plurality of parts,
form a string representation of the part from a plurality of values associated with the part;
determine a numerical representation of the string representation of the part;
for each part of the second plurality of parts,
form a string representation of the part from a plurality of values associated with the part;
determine a numerical representation of the string representation of the part;
determine a mapping between at least some parts of the first table and second table including determining that a first set of one or more parts of the first plurality of parts correspond a second set of one or more parts of the second plurality of parts based at least in part on a similarity between numerical representations of the parts.
